(19) United States
(12) Patent Application Publication
(10) Pub. No.: US 2024/0045351 A1
(43) Pub. Date: Feb. 8, 2024

(54) LIQUID ELECTROPHOTOGRAPHIC INK COMPOSITION

(71) Applicant: Hewlett-Packard Development Company, L.P., Spring, TX (US)

(72) Inventors: Israel PATLA, Nes Ziona (IL); Inna TZOMIK, Nes Ziona (IL); Faina KOGAN, Nes Ziona (IL); Chen ZIGDON, Nes Ziona (IL)

(73) Assignee: Hewlett-Packard Development Company, L.P., Spring, TX (US)

(21) Appl. No.: 18/265,664

(22) PCT Filed: Dec. 16, 2020
(86) PCT No.: PCT/US2020/065326

§ 371 Date: Jun. 6, 2023

(51) Int. Cl. G03G 9/13; G03G 9/12; G03G 15/10; B41M 5/50

(52) U.S. Cl. CPC G03G 9/131; G03G 9/122; G03G 15/10; B41M 5/502

(57) ABSTRACT

Described herein is a liquid electrophotographic ink composition comprising a first thermoplastic resin comprising a copolymer comprising an alkylene monomer and a monomer comprising an epoxide group, and a second thermoplastic resin comprising a copolymer comprising a monomer comprising an anhydride group.

### BACKGROUND

Electrophotographic printing processes, sometimes termed liquid electrophotographic printing processes, involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent liquid electrophotographic image having image and background areas with different potentials. For example, a liquid electrophotographic ink composition including charged particles in a liquid carrier can be brought into contact with the selectively charged photoconductive surface. The charged particles adhere to the image areas of the latent image while the background areas remain clean. The image is then transferred to a print substrate (e.g., a polymer substrate) directly or by being first transferred to an intermediate transfer member, which can be a soft swelling blanket, which is often heated to fuse the solid image and evaporate the liquid carrier, and then to the print substrate.

### BRIEF DESCRIPTION OF THE FIGURES

FIG. 1 shows example heat-sealing results of electroplated samples #1 to #6 in comparison to a reference liquid electrophotographic ink composition.

FIG. 2 shows example heat sealing results of printed samples # 2 and #3 in comparison with two reference liquid electrophotographic ink compositions.

FIG. 3 shows example heat sealing results of printed samples #2 and #3 (without primer) hot-molded to PS yogurt cups.

### DETAILED DESCRIPTION

Liquid electrophotographic printing onto substrates, for example substrates used for flexible packaging, can pose significant challenges due to durability. Some printed inks should present heat-sealing resistance (120° C. to 250° C.), water resistance and mechanical resistance (due to scratch and rub) to maintain print quality through the life cycle of a product.

In some cases, a primer, for example a primer containing a polyethylene imine or a poly(ethylene-co-acrylic acid), is applied before the liquid electrophotographic ink is applied in order for the ink to adhere to a substrate. Moreover, even with the use of a primer, a varnish or laminated overlayer may be used for printed images to be considered water, chemical and heat resistant, as well as resistant to mechanical wear.

It has been found that the use of a first thermoplastic resin comprising a copolymer comprising an alkylene monomer and a monomer comprising an epoxide group, and a second thermo-plastic resin comprising a copolymer comprising a monomer comprising an anhydride group in the liquid electrophotographic ink leads to damage to the print during heat-sealing being significantly reduced and avoided, respectively. This advantageously can permit removing both the primer and the varnish/laminated overlayer when printing on substrates used for example for flexible packaging. By permitting removal of a primer and varnish/laminated overlayer, reductions in machinery cost, maintenance and printing time and cost are also achieved.

It is noted that, as used in this specification and the appended claims, the singular forms “a”, “an”, and “the” include plural referents unless the context clearly dictates otherwise.

As used herein, “liquid carrier”, “carrier”, or “carrier vehicle” refer to the fluid in which the polymer resin, absorber(s), charge directors and/or other additives can be dispersed to form a liquid electrophotographic ink or electrophotographic ink. Liquid carriers can include a mixture of a variety of different agents, such as surfactants, co-solvents, viscosity modifiers, and/or other possible ingredients.

As used herein, “ liquid electrophotographic ink composition” generally refers to an ink composition, which may be in liquid form, generally suitable for use in a liquid electrophotographic printing process, sometimes termed an electrophotographic printing process. The liquid electrophotographic ink composition may include chargeable particles suspended in a liquid carrier, which may be as described herein.

As used herein, “co-polymer” refers to a polymer that is polymerized from at least two monomers. However, a copolymer of a particular list of monomer types (e.g., a copolymer of monomer A and monomer B) refers to a copolymer that is polymerized from monomers of those types and no other types of monomer (e.g. an AB polymer).

As used herein, “melt flow rate” generally refers to the extrusion rate of a resin through an orifice of defined dimensions at a specified temperature and load, usually reported as temperature/load, for example, 190° C./2.16 kg. Flow rates can be used to differentiate grades or provide a measure of degradation of a material as a result of molding. In the present disclosure, “melt flow rate” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the liquid electrophotographic composition.

A certain monomer may be described herein as constituting a certain weight percentage of a polymer. This indicates that the repeating units formed from the said monomer in the polymer constitute said weight percentage of the polymer.

As used herein, “liquid electrostatic(ally) printing” or “liquid electrophotographic(ally) printing” generally refer to the process that provides an image that is transferred from a photo imaging substrate or plate either directly or indirectly via an intermediate transfer member to a print substrate, for example, a polymer substrate. As such, the image is not substantially absorbed into the photo imaging substrate or plate on which it is applied. Additionally, “liquid electrophotographic printers” or “liquid electrostatic printers” generally refer to those printers capable of performing electrophotographic printing or electrostatic printing, as described above. A liquid electrophotographic (LEP) printing process may involve subjecting a liquid electrophotographic ink composition to an electric field, for example, an electric field having a field strength of 1000 V/cm or more, in some examples, 1000 V/mm or more.

As used herein, “LEP image” or “printed LEP image” refer to an image which has been printed, for example, on a print substrate, by liquid electrophotographically printing a LEP ink composition described herein.

As used herein, “NVS” is an abbreviation of the term “non-volatile solids”.

As used herein, the term “about” is used to provide flexibility to a numerical range endpoint by providing that a given value may be a little above or a little below the endpoint. The degree of flexibility of this term can be dictated by the particular variable.

If a standard test is mentioned herein, unless otherwise stated, the version of the test to be referred to is the most recent at the time of filing this patent application.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and subranges within the indicated range. Thus, included in this numerical range are individual values such as 2, 3.5, and 4 and sub-ranges such as from 1-3, from 2-4, and from 3-5, and so on. This same principle applies to ranges reciting a single numerical value. Furthermore, such an interpretation should apply regardless of the breadth of the range or the characteristics being described.

As used herein, unless specified otherwise, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

### Liquid Electrophotographic Ink Composition

The liquid electrophotographic ink composition may comprise a first thermoplastic resin comprising a copolymer comprising an alkylene monomer and a monomer comprising an epoxide group, and a second thermoplastic resin comprising a copolymer comprising a monomer comprising an anhydride group.

The liquid electrophotographic ink composition may be a liquid electrostatic ink composition. The liquid electrophotographic ink may comprise a carrier liquid and a thermoplastic resin, which may be suspended in the carrier liquid. The liquid electrophotographic ink composition may comprise a carrier liquid and chargeable particles suspended in the carrier liquid. The chargeable particles may comprise a thermoplastic resin. The thermoplastic resin may comprise a copolymer of an alkylene monomer and an ethylenically unsaturated monomer comprising an epoxide.

The chargeable particles may comprise a thermoplastic resin and a colorant. In some examples, the liquid electrophotographic ink composition may comprise a thermoplastic resin and a colorant.

In some examples, the liquid electrophotographic ink composition may comprise a thermoplastic resin and a charge director. In some examples, the liquid electrophotographic ink composition may comprise a thermoplastic resin, a colorant and a charge director.

In some examples, the liquid electrophotographic ink composition may comprise a thermoplastic resin and a charge adjuvant. In some examples, the liquid electrophotographic ink composition may comprise a thermoplastic resin, a colorant and a charge adjuvant. In some examples, the liquid electrophotographic ink composition may comprise a thermoplastic resin, a charge director and a charge adjuvant. In some examples, the liquid electrophotographic ink composition may comprise a thermoplastic resin, a colorant, a charge director and a charge adjuvant.

In some examples, the thermoplastic resin constitutes about 10 wt. % to about 99 wt. %, in some examples, about 15 wt. % to about 95 wt. % of the solids of the liquid electrophotographic ink composition. In some examples, the thermoplastic resin constitutes about 20 wt. % to about 95 wt. % of the solids of the liquid electrophotographic ink composition. In some examples, the thermoplastic resin constitutes about 35 wt. % to about 95 wt. %, in some examples, about 75 wt. % to about 95 wt. %, in some examples, about 35 wt.°/0 to about 99 wt. %, in some examples, about 75 wt. % to 99 wt. % of the solids of the liquid electrophotographic ink. In some examples, the thermoplastic resin constitutes about 80 wt. % to 95 wt. % of the solids of the liquid electrophotographic ink composition, in some examples, about 85 wt.°/0 to about 95 wt. % of the solids of the liquid electrophotographic ink composition, in some examples, about 89 wt. % to about 93 wt. % of the solids of the liquid electrophotographic ink composition.

### The First Thermoplastic Resin

In some examples, the first thermoplastic resin comprises a copolymer comprising an alkylene monomer and a monomer comprising an epoxide group. The copolymer comprising an alkylene monomer and a monomer comprising an epoxide group may be referred to herein as “the copolymer”. In some examples, the copolymer consists of an alkylene monomer and a monomer comprising an epoxide group.

In some examples, the copolymer constitutes at least 20 wt. % of the thermoplastic resin, for example, at least 30 wt. %, at least 35 wt. %, at least 40 wt. %, at least 45 wt. %, at least 50 wt. %, and up to 55 wt. %, up to 60 wt.° %, up to 65 wt. %, up to 70 wt. %, up to 75 wt. %, up to 80 wt. % of the thermoplastic resin. In some examples, the copolymer constitutes 25 to 75 wt. % of the thermoplastic resin. In some examples the copolymer constitutes 30 to 60 wt. % of the thermoplastic resin. In some examples the copolymer constitutes 40 to 60 wt. % of the thermoplastic resin. In some examples the copolymer constitutes 45 to 55 wt. % of the thermoplastic resin.

In some examples, the copolymer may have a melt flow rate (190° C./12.16 kg) of 30 g/10 min or less, in some examples, 25 g/10 min or less, in some examples, 20 g/10 min or less, in some examples, 15 g/10 min or less, in some examples, 10 g/10 min or less, in some examples, 9 g/10 min or less, in some examples, 8 g/10 min or less, in some examples, 7 g/10 min or less, in some examples, 6 g/10 min or less, in some examples, about 5 g/10 min. In some examples, the copolymer may have a melt flow rate (190° C./12.16 kg) of 0.5 g/10 min or more, in some examples, 1 g/10 min or more, in some examples, 1.5 g/10 min or more, in some examples, 2 g/10 min or more, in some examples, 2.5 g/10 min or more, in some examples, 3 g/10 min or more, in some examples, 3.5 g/10 min or more, in some examples, 4 g/10 min or more, in some examples, 4.5 g/10 min or more, in some examples, about 5 g/10 min. In some examples, the copolymer may have a melt flow rate (190° C./2.16 kg) of 0.5 g/10 min to 30 g/10 min, in some examples, 1 g/10 min to 25 g/10 min, in some examples, 1.5 g/10 5 min to 20 g/10 min, in some examples, 2 g/10 min to 15 g/10 min, in some examples, 2.5 g/10 min to 10 g/10 min, in some examples, 3 g/10 min to 9 g/10 min, in some examples, 3.5 g/10 min to 8 g/10 min, in some examples, 4 g/10 min to 7 g/10 min, in some examples, 4.5 g/10 min to 6 g/10 min, in some examples, 4 g/10 min to 6 g/10 min.

In some examples, the monomer comprising an epoxide group constitutes from about 2 wt. % to about 30 wt. %, from about 3 wt. % to about 27 wt. %, from about 4 wt. % to about 26 wt. %, from about 4 wt. % to about 25 wt. %, from about 5 wt. % to about 24 wt. %, from about 5wt. % to about 23 wt. %, from about 5 wt. % to about 22 wt. %, from about 5 wt. % to about 21 wt. %, from about 5wt. % to about 20 wt. %, f of the copolymer. The alkylene monomer constitutes the remaining weight percent of the copolymer.

In some examples, the alkylene monomer comprises any alkylene monomer. In some examples, the alkylene monomer comprises a monomer selected from the group consisting of ethylene and propylene. In some example, the alkylene monomer is ethylene.

### The Monomer Comprising an Epoxide Group

In some examples, a monomer comprising an epoxide group is an ethylenically unsaturated monomer comprising an epoxide group.

As used herein, the term “ethylenically unsaturated monomer” is used to indicate the presence of one carbon-carbon double bond in the monomer, which reacts during the polymerisation reaction to form the copolymer, thus forming a carbon-carbon single bond in the copolymer.

In some examples, the ethylenically unsaturated monomer comprising an epoxide group may comprise one or more epoxide groups per molecule. In some examples, the ethylenically unsaturated monomer comprising an epoxide group may comprise one epoxide group per molecule.

In some examples, the ethylenically unsaturated monomer comprising an epoxide group is an ethylenically unsaturated ketone comprising an epoxide group, an ethylenically unsaturated amide comprising an epoxide group, an ethylenically unsaturated thioester comprising an epoxide group, an ethylenically unsaturated ester comprising an epoxide group, or a combination thereof. In some examples, the ethylenically unsaturated monomer comprising an epoxide group is an ethylenically unsaturated ester comprising an epoxide group.

In some examples, the ethylenically unsaturated amide comprising an epoxide group may be an amide of an ethylenically unsaturated carboxylic acid and an epoxide-containing amine, for example, an epoxide-containing primary amine or an epoxide-containing secondary amine.

In some examples, the ethylenically unsaturated thioester comprising an epoxide group may be a thioester of an ethylenically unsaturated carboxylic acid and an epoxide-containing thiol. In some examples, the ethylenically unsaturated ester comprising an epoxide group may be an ester of an ethylenically unsaturated carboxylic acid and an epoxide group-containing alcohol.

In some examples, the ethylenically unsaturated carboxylic acid may be any compound containing a carboxylic acid and a single carbon-carbon double bond. In some examples, the ethylenically unsaturated carboxylic acid comprises an alpha,beta-unsaturated, alpha-alkyl carboxylic acid. In some examples, the alpha,beta-unsaturated, alpha-alkyl carboxylic acid may be further substituted.

In some examples, the alpha,beta-unsaturated, alpha-alkyl carboxylic acid comprises an alpha-alkyl substituted C1 to C10 alpha,beta-unsaturated carboxylic acid, for example, an alpha-alkyl substituted C1 to C6 alpha,beta-unsaturated carboxylic acid. In some examples, the alpha,beta-unsaturated, alpha-alkyl carboxylic acid is selected from the group consisting of a 2-alkylpent-2-enoic acid, 2-alkylbutan-2-enoic acid and a 2-alkylprop-2-enoic acid. In some examples, the alpha,beta-unsaturated, alpha-alkyl carboxylic acid is a 2-alkylprop-2-enoic acid.

In some examples, the alpha-alkyl group of the alpha,beta-unsaturated, alpha-alkyl carboxylic acid is a substituted or unsubstituted alkyl group. In some examples, the alpha-alkyl substituent of the alpha,beta-unsaturated, alpha-alkyl carboxylic acid (for example, the 2-alkyl substituent of 2-alkylprop-2-enoic acid) is a C1 to C10 alkyl group, for example, a C1 to C6 alkyl, such as methyl, ethyl, propyl (e.g., n-propyl or isopropyl), or butyl (e.g., n-butyl, sec-butyl, isobutyl or tert-butyl). In some examples, the 2-alkyl substituent of the alpha,beta-unsaturated, alpha-alkyl carboxylic acid (for example, the 2-alkyl substituent of 2-alkylprop-2-enoic acid) is selected from the group consisting of methyl, ethyl and propyl. In some examples, the alpha-alkyl substituent of the alpha,beta-unsaturated, alpha-alkyl carboxylic acid is methyl.

In some examples, the ethylenically unsaturated carboxylic acid is selected from 2-propylprop-2-enoic acid, 2-ethylprop-2-enoic acid and 2-methylprop-2-enoic acid. In some examples, the ethylenically unsaturated carboxylic acid is 2-methylprop-2-enoic acid, which can also be named methacrylic acid.

In some examples, the epoxide-containing alcohol may be any compound containing an epoxide group and an alcohol group. In some examples, the epoxide-containing alcohol may be any alkane containing an epoxide group and an alcohol.

In some examples, the epoxide-containing alcohol comprises a primary alcohol, a secondary alcohol or a tertiary alcohol. In some examples, the epoxide-containing alcohol comprises a primary alcohol.

In some examples, the epoxide-containing alcohol may comprise a mono-substituted epoxide (also referred to herein as a terminal epoxide), a disubstituted epoxide, a tri-substituted epoxide or a tetra-substituted epoxide. In some examples, the epoxide-containing alcohol may comprise a mono-substituted or a disubstituted epoxide group. In some examples, the epoxide-containing alcohol may comprise a terminal epoxide. In some examples, the disubstituted epoxide may have the formula —CR(O)CH₂. A terminal epoxide is an epoxide having the formula —CH(O)CH₂.

In some examples, the epoxide-containing alcohol may comprise a primary alcohol and a terminal epoxide group.

In some examples, the epoxide-containing alcohol may be any epoxide-containing alcohol. In some examples, the epoxide-containing alcohol may comprise 2 to 30 carbon atoms, for example, 3 to 25 carbon atoms, 3 to 20 carbon atoms, 3 to 15 carbon atoms, 3 to 10 carbon atoms, 3 to 5 carbon atoms, 3 to 4 carbon atoms. In some examples, the epoxide-containing alcohol may be selected from glycidol (i.e., 2,3-epoxy-1-propanol), epoxybutanol (e.g., 3,4-epoxy-1-butanol), epoxypentanol (e.g., 4,5-epoxy-1-pentanol). In some examples, the epoxide-containing alcohol may be glycidol.

In some examples, the ethylenically unsaturated ester comprising an epoxide may be selected from glycidyl methacrylate, glycidyl 2-ethylprop-2-enoate, glycidyl 2-propylprop-2-enoate, epoxybutanyl methacrylate, epoxybutanyl 2-ethylprop-2-enoate, epoxybutanyl 2-propylprop-2-enoate, epoxypentanyl methacrylate, epoxypentanyl 2-ethylprop-2-enoate, epoxypentanyl 2-propylprop-2-enoate. In some examples, the ethylenically unsaturated ester comprising an epoxide is glycidyl methacrylate. In some examples, the copolymer of the first thermoplastic resin is poly(ethylene-co-glycidyl methacrylate).

### The Second Thermoplastic Resin

In some examples, the second thermoplastic resin comprises a copolymer comprising a monomer comprising an anhydride group. In some examples, the monomer comprising an anhydride group is an ethylenically unsaturated monomer comprising an anhydride.

In some examples, the second thermoplastic resin comprises a copolymer of an ethylenically unsaturated monomer comprising an anhydride group and an alkenoic acid alkyl ester monomer. In some examples, the second thermoplastic resin comprises a copolymer which comprises at least one monomer selected from the group consisting of an alkylene monomer and alkenoic acid alkyl ester monomer.

In some examples, the second thermoplastic resin comprises a copolymer that consists of an ethylenically unsaturated monomer comprising an anhydride group and an alkenoic acid alkyl ester monomer.

In some examples, the second thermoplastic resin comprises a copolymer of an ethylenically unsaturated monomer comprising an anhydride group, an alkenoic acid alkyl ester monomer, and an alkylene monomer.

In some examples, the second thermoplastic resin consists of a copolymer of an ethylenically unsaturated monomer comprising an anhydride group, an alkenoic acid alkyl ester monomer, and an alkylene monomer. In these examples, the monomer comprising the anhydride groups is present in from about 1 to about 5 wt. %, or from about 1.5 to about 4 wt. %, or from about 2 to about 4 wt. %, or from about 2.5 to about 4.0 wt. %, or from about 2.5 to about 3.5. The alkenoic acid alkyl ester is present in from about 3 to about 10 wt. %, or from about 4 to about 9 wt. %, or from about 4 to about 8 wt. % or from about 5 to about 8 wt. %. The remaining weight percent are made up by the alkylene monomer.

In some examples, the ethylenically unsaturated monomer comprising an anhydride group is a substituted or unsubstituted butenedioic anhydride. In some examples, the ethylenically unsaturated monomer comprising an anhydride group is maleic acid anhydride.

In some examples, the alkenoic acid alkyl ester monomer is a substituted or unsubstituted alpha,beta unsaturated C3 to C5 alkenoic acid alkyl ester monomer. In some examples, the alpha,beta unsaturated C3 to C5 alkenoic acid alkyl ester monomer is C1 to C4-alkyl ester monomer. In some examples, the alpha,beta unsaturated C3 to C5 alkenoic acid alkyl ester monomer is a propenoic-C1 to C4 alkyl ester monomer, a butenoic-Cl to C4 alkyl ester monomer, or a pentenoic-C1 to C4 alkyl ester monomer. In some examples, it is a methacrylate-C1 to C4 alkyl ester monomer. In some examples, it is an acrylate-C1 to C4 alkyl ester monomer. In some examples it is an ethylacrylate monomer.

In some examples, the alkylene monomer comprises a monomer selected from the group consisting of ethylene and propylene. In some example, the alkylene monomer is ethylene.

In some examples, the second thermoplastic resin is a poly(ethylene-coethylacrylate-co-maleic acid anhydride) copolymer. In these examples, the maleic acid anhydride monomer is present in from about 1 to about 5 wt. %, or from about 1.5 to about 4 wt. %, or from about 2 to about 4 wt. %, or from about 2.5 to about 4.0 wt. %, or from about 2.5 to about 3.5. The ethylacrylate monomer is present in from about 3 to about 10 wt. %, or from about 4 to about 9 wt. %, or from about 4 to about 8 wt. % or from about 5 to about 8 wt. %. The remaining weight percent are made up by the alkylene monomer. In some examples, the maleic acid anhydride monomer is present in from about 2 to about 4 wt. % and the ethylacrylate monomer is present in from about 5 to about 8 wt. %, the reminder being the ethylene monomer.

In some examples, the second thermoplastic resin is a poly(ethylacrylateco-maleic acid anhydride) copolymer.

### Colorant

A liquid electrophotographic ink composition may comprise a colorant. The color-ant may be a dye or a pigment. The colorant can be any colorant compatible with the liquid carrier and useful for electrophotographic printing. For example, the colorant may be present as pigment particles or may comprise a resin (in addition to the resins described herein) and a pigment. The resins and pigments can be any of those standardly used. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM®

SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. In some examples, the pigment may be a white pigment. Where the pigment is a white pigment particle, the pigment particle may be selected from the group consisting of TiO₂, calcium carbonate, zinc oxide, and mixtures thereof. In some examples, the white pigment particle may comprise an alumina—TiO₂ pigment.

In some examples, the colorant or pigment particles may have a median particle size (particle diameter) or d₅₀ of 20 pm or less, for example, 15 pm or less, for example, 10 pm or less, for example, 5 pm or less, for example, 4 pm or less, for example, 3 pm or less, for example, 2 pm or less, for example, 1 pm or less, for example, 0.9 pm or less, for example, 0.8 pm or less, for example, 0.7 pm or less, for example, 0.6 pm or less, for example, 0.5 pm or less. Unless otherwise stated, the particle size of the colorant or pigment particle and the resin coated pigment particle is determined by using laser diffraction on a Malvern Mastersizer 2000 according to the standard procedure as described in the operating manual.

The colorant or pigment particle may be present in a liquid electrophotographic ink composition in an amount of from 10 wt. % to 80 wt. % of the total amount of resin and pigment, in some examples, 15 wt. % to 80 wt. %, in some examples, 15 wt. % to 60 wt. %, in some examples, 15 wt. % to 50 wt. %, in some examples, 15 wt. % to 40 wt. %, in some examples, 15 wt. % to 30 wt. % of the total amount of resin and colorant. In some examples, the colorant or pigment particle may be present in a liquid electrophotographic ink composition in an amount of at least 50 wt. % of the total amount of resin and colorant or pigment, for example, at least 55 wt. % of the total amount of resin and colorant or pigment.

### Liquid Carrier

In some examples, for example, when printing, the liquid electrophotographic ink composition comprises a liquid carrier. Generally, the liquid carrier can act as a dispersing medium for the other components in the liquid electrophotographic ink composition. For example, the liquid carrier can comprise or be a hydrocarbon, silicone oil, vegetable oil, or the like. The liquid carrier can include, but is not limited to, an insulating, non-polar, non-aqueous liquid that can be used as a medium for toner particles. The liquid carrier can include compounds that have a resistivity in excess of about 10⁹ ohm·cm. The liquid carrier may have a dielectric constant below about 5, in some examples, below about 3. The liquid carrier can include, but is not limited to, hydrocarbons. The hydrocarbon can include, but is not limited to, an aliphatic hydrocarbon, an isomerized aliphatic hydrocarbon, a branched chain aliphatic hydrocarbon, an aromatic hydrocarbon, and combinations thereof. Examples of the liquid carrier include, but are not limited to, aliphatic hydrocarbons, isoparaffinic compounds, paraffinic compounds, dearomatized hydrocarbon compounds, and the like. In particular, the liquid carrier can include, but is not limited to, Isopar-G™, Isopar-H™, Isopar-L™, Isopar-M™, Isopar-K™, Isopar-V™ Norpar 12™, Norpar 13™, Norpar 15™, Exxol D40™, Exxol D80™, Exxol D100™ Exxol D130™, and Exxol D140™ (each sold by EXXON CORPORATION); Teclen N-16™, Teclen N-20™, Teclen N-22™, Nisseki Naphthesol L™, Nisseki Naphthesol M™ Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before liquid electrophotographic printing, the liquid carrier can constitute about 20% to 99.5% by weight of the liquid electrophotographic ink composition, in some examples, 50% to 99.5% by weight of the liquid electrophotographic ink composition. Before printing, the liquid carrier may constitute about 40 to 90% by weight of the liquid electrophotographic ink composition. Before printing, the liquid carrier may constitute about 60% to 80% by weight of the liquid electrophotographic ink composition. Before printing, the liquid carrier may constitute about 90% to 99.5% by weight of the liquid electrophotographic ink composition, in some examples, 95% to 99% by weight of the liquid electrophotographic ink composition.

The liquid electrophotographic ink, when liquid electrophotographic printed, may be substantially free from liquid carrier. In a liquid electrophotographic printing process and/or afterwards, the liquid carrier may be removed, for example, by an electrophoresis processes during printing and/or evaporation, such that substantially just solids are transferred to the substrate. Substantially free from liquid carrier may indicate that the ink printed on the substrate contains less than wt. % liquid carrier, in some examples, less than 2 wt. % liquid carrier, in some examples, less than 1 wt. % liquid carrier, in some examples, less than 0.5 wt. % liquid carrier. In some examples, the ink printed on the substrate is free from liquid carrier.

### Charge Director

In some examples, the liquid electrophotographic ink composition includes a charge director.

The charge director may be added in order to impart and/or maintain sufficient electrostatic charge on ink particles during liquid electrophotographic printing, which may be chargeable particles comprising a thermoplastic resin comprising a copolymer of an alkylene monomer and an ethylenically unsaturated monomer comprising an epoxide. The charge director may comprise ionic compounds, particularly metal salts of fatty acids, metal salts of sulfosuccinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, and the like. The charge director can be selected from, but is not limited to, oil-soluble petroleum sulfonates (e.g., neutral Calcium Petronate™, neutral Barium Petronate™, and basic Barium Petronate™, polybutylene succinimides (e.g., OLOA™ 1200 and Amoco 575), and glyceride salts (e.g., sodium salts of phosphated mono- and diglycerides with unsaturated and saturated acid substituents), sulfonic acid salts including, but not limited to, barium, sodium, calcium, and aluminium salts of sulfonic acid. The sulfonic acids may include, but are not limited to, alkyl sulfonic acids, aryl sulfonic acids, and sulfonic acids of alkyl succinates. The charge director can impart a negative charge or a positive charge on the chargeable particles of a liquid electrophotographic ink composition.

In some examples, the liquid electrophotographic ink composition comprises a charge director comprising a simple salt. Simple salts are salts that do not form micelles by themselves, although they may form a core for micelles with a micelle forming salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of S0₄²⁻, P0³⁻, NO³⁻, HP0₄²⁻, C0₃²⁻, acetate, trifluoroacetate (TFA), Cl⁻, BF⁻₄, F⁻, CI0₄⁻, and Ti0₃⁴⁻, or from any sub-group thereof. The simple salt may be selected from CaCO₃, Ba₂TiO₃, Al₂(S0₄), Al(NO₃)₃, Ca₃(PO₄)₂, BaSO₄, BaHPO₄, Ba₂(P0₄)₃, CaSO₄, (NH₄)₂CO₃, (NH₄)₂S0₄, NH₄OAc, tert-butyl ammonium bromide, NH₄NO₃, LiTFA, Al₂(S0₄)₃, LiCiO₄ and LiBF₄, or any sub-group thereof.

The charge director may include at least one of (i) soya lecithin, (ii) a barium sulfonate salt, such as basic barium petronate (BBP), and (iii) an isopropyl amine sulfonate salt. Basic barium petronate is a barium sulfonate salt of a C21-26 hydrocarbon alkyl, and can be obtained, for example, from Chemtura. An example isopropyl amine sulfonate salt is dodecyl benzene sulfonic acid isopropyl amine, which is available from Croda.

In some examples, the liquid electrophotographic ink composition comprises a charge director comprising a sulfosuccinate salt of the general formula MAₙ, wherein M is a metal, n is the valence of M, and A is an ion of the general formula (I):

[R¹—O—C(O)CH₂CH(SO0₃)C(O)—O—R²]⁻ 70.I

wherein each of R¹ and R² is an alkyl group.

The sulfosuccinate salt of the general formula MA, is an example of a micelle forming salt. The charge director may be substantially free of or free of an acid of the general formula HA, where A is as described above. The charge director may include micelles of said sulfosuccinate salt enclosing at least some of the nanoparticles. The charge director may include at least some nanoparticles having a size of 200 nm or less, and/or, in some examples, 2 nm or more.

In the formula [R¹-0-C(0)CH₂CH(S0₃)C(0)-0-R²], in some examples, each of R¹ and R² is an aliphatic alkyl group. In some examples, each of R¹ and R² independently is a C3 to C30 alkyl, for example, C6-25 alkyl, C10 to C20 alkyl or C11 to C15 alkyl. In some examples, R¹ and R² are both C13 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same or different. In some examples, R¹ and R² are the same. In some examples, at least one of R¹ and R² is C13H27. In some examples, M is Na, K, Cs, Ca, or Ba.

In some examples, the charge director constitutes about 0.001 to 20% by weight, in some examples, 0.01 to 20% by weight, in some examples, 0.01 to 10% by weight, in some examples, 0.01 to 1% by weight of the solids of the liquid electrophotographic ink composition. In some examples, the charge director constitutes about 0.001 to 0.15% by weight of the solids of the liquid electrophotographic ink composition, in some examples, 0.001 to 0.15%, in some examples, 0.001 to 0.02% by weight of the solids of the liquid electrophotographic ink composition, in some examples, 0.1 to 2% by weight of the solids of the liquid electrophotographic ink composition, in some examples, 0.2 to 1.5% by weight of the solids of the liquid electrophotographic ink composition, in some examples, 0.1 to 1% by weight of the solids of the liquid electrophotographic ink composition, in some examples, 0.2 to 0.8% by weight of the solids of the liquid electrophotographic ink composition. In some examples, the charge director is present in an amount of at least 1 mg of charge director per gram of the liquid electrophotographic ink composition (which will be abbreviated to mg/g), in some examples, at least 2 mg/g, in some examples, at least 3 mg/g, in some examples, at least 4 mg/g, in some examples, at least 5 mg/g. In some examples, the charge director is present in an amount of from 1 mg to 50 mg of charge director per gram of the liquid electrophotographic ink composition (which will be abbreviated to mg/g), in some examples, from 1 mg/g to 25 mg/g, in some examples, from 1 mg/g to 20 mg/g, in some examples, from 1 mg/g to 15 mg/g, in some examples, from 1 mg/g to 10 mg/g, in some examples, from 3 mg/g to 20 mg/g, in some examples, from 3 mg/g to 15 mg/g, in some examples, from 5 mg/g to 10 mg/g.

In some examples, the charge director does not react with the epoxide group in the copolymer of an alkylene monomer and an ethylenically unsaturated monomer comprising an epoxide. In some examples, a sulfosuccinate salt based charge director may provide better charging stability than a charge director containing an amine (for example, the charge director comprising a mixture of soya lecithin, a barium sulfonates alt and an isopropyl amine sulfonate salt), thus prolonging the lifespan of the charged liquid electrophotographic ink composition. In some examples, the charging stability is not affected by the presence of an amine in the charge director.

### Charge Adjuvant

In some examples, the liquid electrophotographic ink composition includes a charge adjuvant. A charge adjuvant may promote charging of the chargeable particles when a charge director is present in the liquid electrophotographic ink composition during printing. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant is or includes aluminium di- or tristearate. The charge adjuvant may be present in an amount of about 0.1 to 5% by weight, in some examples, about 0.1 to 1% by weight, in some examples, about 0.3 to 0.8% by weight of the solids of the liquid electrophotographic ink composition, in some examples, about 1 to 3% by weight of the solids of the liquid electrophotographic ink composition, in some examples, about 1.5 to 2.5% by weight of the solids of the liquid electrophotographic ink composition.

In some examples, the liquid electrophotographic ink composition further includes, for example, as a charge adjuvant, a salt of a multivalent cation and a fatty acid anion. The salt of a multivalent cation and a fatty acid anion can act as a charge adjuvant. The multivalent cation may, in some examples, be a divalent or a trivalent cation. In some examples, the multivalent cation is selected from Group 2, transition metals, Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C8 to C26 fatty acid anion, in some examples, a C14 to C22 fatty acid anion, in some examples, a C16 to C20 fatty acid anion, in some examples, a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the solids of the liquid electrophotographic ink composition, in some examples, in an amount of 0.1 wt. % to 2 wt. % of the solids of the liquid electrophotographic ink composition, in some examples, in an amount of 0.1 wt. % to 2 wt. % of the solids of the liquid electrophotographic ink composition, in some examples, in an amount of 0.3 wt. % to 1.5 wt. % of the solids of the liquid electrophotographic ink composition, in some examples, about 0.5 wt. % to 1.2 wt. % of the solids of the liquid electrophotographic ink composition, in some examples, about 0.8 wt. % to 1 wt. % of the solids of the liquid electrophotographic ink composition, in some examples, about 1 wt. % to 3 wt. % of the solids of the liquid electrophotographic ink composition, in some examples, about 1.5 wt. % to 2.5 wt. % of the solids of the liquid electrophotographic ink composition.

### Additives

The liquid electrophotographic ink composition may include an additive or a plurality of additives. The additive or plurality of additives may be added at any stage of the method of producing the liquid electrophotographic ink composition. The additive or plurality of additives may be selected from a wax, a surfactant, biocides, organic solvents, viscosity modifiers, materials for pH adjustment, sequestering agents, preservatives, compatibility additives, emulsifiers and the like. The wax may be an incompatible wax. As used herein, “incompatible wax” may refer to a wax that is incompatible with the thermoplastic resin. Specifically, the wax phase separates from the resin phase upon the cooling of the resin fused mixture on a print substrate during and after the transfer of the ink film to the print substrate, for example, from an intermediate transfer member, which may be a heated blanket.

### Method of Producing the Liquid Electrophotographic Ink Composition

In some examples, there is provided a method of producing a liquid electrophotographic ink composition. The method may comprise processing a first thermoplastic resin comprising a copolymer comprising an alkylene monomer and a monomer comprising an epoxide, and a second thermoplastic resin comprising a copolymer comprising a monomer comprising an anhydride group to form a liquid electrophotographic ink.

In some examples the method may comprise processing a first thermoplastic resin comprising a polymer of an ethylenically unsaturated monomer comprising an epoxide, and a second thermoplastic resin comprising a polymer of an ethylenically unsaturated monomer comprising an anhydride and an alkenoic acid alkyl ester monomer.

In some examples, the method of producing a liquid electrophotographic ink composition may comprise combining a second thermoplastic resin and a first thermoplastic resin such that the molar ratio of the anhydride group of the copolymer of the second thermoplastic resin to the monomer comprising an epoxide of the copolymer of the first thermoplastic resin is from about 0.3 to about 1.7. In another example the ratio is from about 0.4 to about 1.7. In another example the ratio is from about 0.4 to about 1.6. In another example the ratio is from about 0.5 to about 1.5. In another example the ratio is from about 0.7 to about 1.3. In another example the ratio is from about 0.8 to about 1.2. In a preferred example, the ratio is 0.5 to 1.5. In another preferred example the ratio is 1.5. In all instances the molar ratio is based on the weight percentage of the monomer comprising the anhydride group in the second thermoplastic resin and the weight percentage of the monomer comprising the epoxide group in the first thermoplastic resin. Methods of determining weight percentages of epoxide and anhydride groups, respectively, in polymers are for instance determination of epoxy numbers by titration and acid number determination of anhydrides by titration. The epoxy content of epoxy resins is determined according to Standard Test Method ASTM D1652. The acid number of maleic anhydride resins is determined according to Standard Test Method ASTM D3644.

In some examples, the method of producing a liquid electrophotographic ink composition may comprise polymerising an alkylene monomer and an ethylenically unsaturated monomer comprising an epoxide to form a first thermoplastic resin of an alkylene monomer and an ethylenically unsaturated monomer comprising an epoxide, and also polymerising a monomer comprising an anhydride group to form a second thermoplastic resin.

In some examples, the method of producing a liquid electrophotographic ink composition may comprise polymerising an ethylenically unsaturated monomer comprising an epoxide to form a first thermoplastic resin, and also polymerising a polymer of an ethylenically unsaturated monomer comprising an anhydride and an alkenoic acid alkyl ester monomer to form a second thermoplastic resin.

In some examples, the method of producing a liquid electrophotographic ink composition may comprise suspending in a carrier liquid a first thermoplastic resin comprising a copolymer comprising an alkylene monomer and a monomer comprising an epoxide, and a second thermoplastic resin comprising a copolymer comprising a monomer comprising an anhydride group.

In some examples the method of producing a liquid electrophotographic ink composition may comprise suspending in a carrier liquid a first thermoplastic resin comprising a polymer of an ethylenically unsaturated monomer comprising an epoxide, and a second thermoplastic resin comprising a polymer of an ethylenically unsaturated monomer comprising an anhydride and an alkenoic acid alkyl ester monomer.

In some examples, the method of producing a liquid electrophotographic ink composition may comprise suspending in a carrier liquid chargeable particles comprising a first thermoplastic resin comprising a copolymer comprising an alkylene monomer and a monomer comprising an epoxide, and a second thermoplastic resin comprising a copolymer comprising a monomer comprising an anhydride group.

In some examples, the method of producing a liquid electrophotographic ink composition may comprise suspending in a carrier liquid chargeable particles comprising a first thermoplastic resin comprising a polymer of an ethylenically unsaturated monomer comprising an epoxide, and a second thermoplastic resin comprising a polymer of an ethylenically unsaturated monomer comprising an anhydride and an alkenoic acid alkyl ester monomer.

In some examples, the method of producing a liquid electrophotographic ink composition may comprise combining the thermoplastic resin and the carrier liquid. In some examples, the thermoplastic resin and the carrier liquid are combined and heated to an elevated temperature. In some examples, the thermoplastic resin and the carrier liquid are combined and heated to a temperature of at least 70° C., for example, at least 80° C., for example, at least 90° C., for example, at least 100° C., for example, at least 110° C., for example, at least 120° C., for example, 130° C., for example, to melt the thermoplastic resin. In some examples, the thermoplastic resin and the carrier liquid are heated until the thermoplastic resin has melted and/or dissolved in the carrier liquid. Melting and/or dissolving of the thermoplastic resin in the carrier liquid may result in the carrier fluid appearing clear and homogeneous. In some examples, the thermoplastic resin and carrier liquid are heated before, during or after mixing. In some examples, the thermoplastic resin and the carrier liquid are mixed at a mixing rate of 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the first resin in the carrier liquid is complete. In some examples, the rate of cooling of the thermoplastic resin and the carrier liquid is controlled, for example, cooling occurs at a rate of, for or less, for example, 5° C./min or less, 4° C./min or less, 3° C./min or less, 2° C./min or less, 1° C./min or less.

In some examples, the thermoplastic resin and the carrier liquid are combined, causing the thermoplastic resin to swell with the carrier liquid. In some examples, the thermoplastic resin and the carrier liquid are combined and heated, causing the thermoplastic resin to swell with the carrier liquid. In some examples, the thermoplastic resin and the carrier liquid are combined and heated, causing swelling and solvation of the thermoplastic resin with the carrier liquid.

In some examples, the method comprises adding a colorant to the thermoplastic resin and the carrier liquid. In some examples, the method comprises adding a colorant to the thermoplastic resin and the carrier liquid to form chargeable particles comprising the thermoplastic resin and a colorant. In some examples, the method comprises grinding the colorant and the thermoplastic resin in the presence of the carrier liquid to form a paste. In some examples, the method comprises heating and mixing the colorant and the thermoplastic resin in the presence of the carrier liquid to form a paste.

In some examples, the method comprises adding a charge adjuvant to the thermoplastic resin and the carrier liquid and, in some examples, grinding. In some examples, the method comprises adding a charge adjuvant and a colorant to the thermoplastic resin and the carrier liquid and optionally grinding.

In some examples, the method comprises grinding at a grinding speed of at least 50 rpm. In some examples, the method comprises grinding at a grinding speed of up to about 600 rpm. In some examples, the method comprises grinding for at least 1 h, in some examples, for at least 2 h. In some examples, the method comprises grinding for up to about 12 h. In some examples, the method comprises grinding at a temperature of at least about 35° C. In some examples, the method comprises grinding at a temperature of at least about 50° C. for a first time period, in some examples, for at least 1 h, in some examples, for at least 1.5 h and then reducing the temperature to a temperature of at least 30° C., in some examples, at least 35° C. and continuing grinding for at least 5 h, in some examples, at least 9 h, in some examples, at least 10 h.

### Method of Printing

The method of printing may comprise liquid electrophotographically printing an liquid electrophotographic ink composition on a surface of a substrate, the liquid electrophotographic ink composition comprising a first thermoplastic resin comprising a polymer of an ethylenically unsaturated monomer comprising an epoxide, and a second thermoplastic resin comprising a polymer of an ethylenically unsaturated monomer comprising an anhydride and an alkenoic acid alkyl ester monomer; and reacting the liquid electrophotographic ink composition with the surface of the substrate.

The method of printing may comprise liquid electrophotographically printing an liquid electrophotographic ink composition on a surface of a substrate, the liquid electrophotographic ink composition comprising a first thermoplastic resin comprising a copolymer comprising an alkylene monomer and a monomer comprising an epoxide group, and a second thermoplastic resin comprising a copolymer comprising a monomer comprising an anhydride group; and reacting the liquid electrophotographic ink composition with the surface of the substrate.

In some examples, the method of printing comprises liquid electrophotographically printing a liquid electrophotographic ink composition.

In some examples, liquid electrophotographically printing a liquid electrophotographic ink composition comprises contacting the liquid electrophotographic ink composition with a latent liquid electrophotographic image on a surface to create a developed image and transferring the developed image to the substrate, in some examples, via an intermediate transfer member.

In some examples, the surface on which the (latent) liquid electrophotographic image is formed or developed may be on a rotating member, for example, in the form of a cylinder. The surface on which the (latent) liquid electrophotographic image is formed or developed may form part of a photoimaging plate. The method may involve passing the liquid electrophotographic ink composition between a stationary electrode and a rotating member, which may be a member having the surface having the (latent) liquid electrophotographic image thereon or a member in contact with the surface having the (latent) liquid electrophotographic image thereon. A voltage is applied between the stationary electrode and the rotating member, such that particles adhere to the surface of the rotating member. The intermediate transfer member, if present, may be a rotating flexible member, which may be heated, for example, to a temperature of from 80 to 160° C.

In some examples, reacting the liquid electrophotographic ink composition with the surface of the substrate causes ring-opening of the epoxide and ring opening of the anhydride, resulting in the formation of a bond between the respective polymers and the substrate, while also a ring opened anhydride group and an epoxy group react and form crosslinks.

In some examples, reacting the liquid electrophotographic ink composition with the surface of the substrate comprises heating the electrostatically printed substrate. In some examples, reacting the liquid electrophotographic ink composition with the surface of the substrate comprises heating to an elevated temperature. In some examples, heating to an elevated temperature comprises heating to a temperature that initiates the reaction of the epoxide with the surface of the substrate.

In some examples, heating to an elevated temperature comprises heating to any temperature that initiates the reaction of the epoxide and the anhydride with the surface of the substrate but does not damage, for example, melt, the substrate. In some examples, heating to an elevated temperature comprises heating to any temperature that initiates the reaction of the epoxide with the surface of the substrate but does not damage the developed image on the surface of the substrate. In some examples, heating to an elevated temperature comprises heating to at least 70° C., for example, at least 80° C., at least 90° C., at least 100° C., at least 105° C., at least 110° C., at least 115° C. or at least 120° C. In some examples, heating to an elevated temperature comprises heating to 200° C. or less, for example, 190° C. or less, 180° C. or less, 170° C. or less, 160° C. or less,150° C. or less, 140° C. or less, 135° C. or less, 130° C. or less, 125° C. or less or 120° C. or less. In some examples, heating to an elevated temperature comprises heating to 70° C. to 200° C., for example, 80° C. to 190° C., 90° C. to 180° C., 100° C. to 170° C., 105° C. to 160° C., 110° C. to 150° C., 115° C. to 140° C., 120° C. to 135° C., 70° C. to 130° C., 80° C. to 125° C. or 90° C. to 120° C.

In some examples, before the liquid electrophotographic ink composition is liquid electrophotographically printed on the substrate, an oxidizing treatment is performed on the substrate. In some examples, before the liquid electrophotographic ink composition is electrostatically printed on the substrate, a corona treatment is performed on the substrate. The corona treatment may improve the surface polarity. During the corona treatment, polar groups, such as hydroxyl, ketone and carboxyl groups, may be grafted onto the surface of the substrate. The substrate may be pre-treated in a corona chamber at room temperature and atmospheric pressure.

In some examples, the method of printing may comprise oxidizing the surface of a substrate; liquid electrophotographically printing an liquid electrophotographic ink composition on the surface of the substrate, the liquid electrophotographic ink composition comprising a first thermoplastic resin comprising a polymer of an ethylenically unsaturated monomer comprising an epoxide, and a second thermoplastic resin comprising a polymer of an ethylenically unsaturated monomer comprising an anhydride and an alkenoic acid alkyl ester monomer; and reacting the liquid electrophotographic ink composition with the surface of the substrate.

In some examples, the method of printing may comprise oxidizing the surface of a substrate; liquid electrophotographically printing an liquid electrophotographic ink composition on the surface of the substrate, the liquid electrophotographic ink composition comprising a first thermoplastic resin comprising a copolymer comprising an alkylene monomer and a monomer comprising an epoxide group, and a second thermoplastic resin comprising a copolymer comprising a monomer comprising an anhydride group; and reacting the liquid electrophotographic ink composition with the surface of the substrate.

In some examples, the method of printing may comprise performing a corona treatment on a surface of a substrate; liquid electrophotographically printing an liquid electrophotographic ink composition on the surface of the substrate, the liquid electrophotographic ink composition comprising a first thermoplastic resin comprising a polymer of an ethylenically unsaturated monomer comprising an epoxide, and a second thermoplastic resin comprising a polymer of an ethylenically unsaturated monomer comprising an anhydride and an alkenoic acid alkyl ester monomer; and reacting the liquid electrophotographic ink composition with the surface of the substrate.

In some examples, the method of printing may comprise performing a corona treatment on a surface of a substrate; liquid electrophotographically printing an liquid electrophotographic ink composition on the surface of the substrate, the liquid electrophotographic ink composition comprising a first thermoplastic resin comprising a copolymer comprising an alkylene monomer and a monomer comprising an epoxide group, and a second thermoplastic resin comprising a copolymer comprising a monomer comprising an anhydride group; and reacting the liquid electrophotographic ink composition with the surface of the substrate.

### Printed Substrate

In some examples, there is provided a substrate having liquid electrophotographically printed thereon a liquid electrophotographic ink composition comprising a first thermoplastic resin comprising a copolymer comprising an alkylene monomer and a monomer comprising an epoxide group, and a second thermoplastic resin comprising a copolymer comprising a monomer comprising an anhydride group such that the epoxide and the anhydride have reacted with each other and the surface of the substrate.

In some examples, there is provided a substrate having liquid electrophotographically printed thereon an liquid electrophotographic ink composition comprising a first thermoplastic resin comprising a polymer of an ethylenically unsaturated monomer comprising an epoxide, and a second thermoplastic resin comprising a polymer of an ethylenically unsaturated monomer comprising an anhydride and an alkenoic acid alkyl ester monomer such that the epoxide and the anhydride have reacted with each other and the surface of the substrate.

In some examples, the such that the epoxide and the anhydride have reacted with each other and the surface of the substrate such that bonds have been formed between the respective copolymers or polymers and the substrate, as well as between the epoxide and the ring opened anhydride.

In some examples, the epoxide has reacted with the surface of the substrate in a ring-opening reaction. In some examples, the anhydride has reacted with the surface of the substrate in a ring-opening reaction. In some examples, the ring opened anhydride reacts with the epoxide.

In some examples, the substrate is not treated with a primer before printing on the substrate. In some examples the substrate is not treated with a varnish or an additional laminating operation after printing.

### Substrate

In some examples, the substrate is any substrate capable of having a liquid electrophotographic ink composition liquid electrophotographically printed thereon.

In some examples, the substrate is any substrate having a surface capable of reacting with an epoxide and anhydride. In some examples, the substrate is any substrate having a surface that, after an oxidizing treatment, is capable of reacting with an epoxide and anhydride. In some examples, the substrate is any substrate having a surface that, after corona treatment, is capable of reacting with an epoxide and anhydride.

In some examples, the substrate may include a material selected from an organic or inorganic material. The substrate may include a natural polymeric material or a synthetic polymeric material.

In some examples, the natural polymeric material may be cellulose. In some examples, the substrate comprises cellulosic paper. In some examples, the cellulosic paper is coated with a polymeric material, for example, a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. In some examples, the substrate is a cellulosic substrate such as paper. The cellulosic substrate may be an uncoated cellulosic substrate or a coated cellulosic substrate.

In some examples, the substrate comprises any suitable textile or fabric substrate. In some examples, the textile or fabric substrate may be a network of natural or synthetic fibres. The fabric substrate may be woven or non-woven. The textile or fabric substrate may be formed of yarns, for example, spun threads or filaments, which may be natural or synthetic material or a combination thereof. The textile or fabric substrate may include substrates that have fibres that may be natural and/or synthetic. The substrate may comprise any textile, fabric material, fabric clothing, or other fabric product onto which it is desired to apply printed matter. The term “textile” includes, by way of example, cloth, fabric material, fabric clothing or other fabric products. The textile substrate may have warp and weft yarns. The terms “warp” and “weft” refer to weaving terms that have their ordinary meaning in the textile arts, that is, warp refers to lengthwise or longitudinal yarns on a loom whereas weft refers to crosswise or transverse yarns on a loom. The textile substrate may be woven, non-woven, knitted, tufted, crocheted, knotted, and/or have a pressed structure.

In some examples, the substrate may include a metal, which may be in sheet form. In some examples, the substrate may comprise a metallic foil or a metallized substrate. In some examples, the substrate may comprise an aluminium foil. In some examples, the substrate may comprise a metallized paper (i.e., paper having a metal layer thereon) or a metallized plastic substrate (i.e., a plastic substrate having a metal layer thereon).

The metal may be selected from or made from, for example, aluminium (AI), silver (Ag), tin (Sn), copper (Cu), or mixtures thereof.

In some examples, the substrate is a polymer substrate. In some examples, the polymer substrate may be a copolymer. In some examples, the polymer substrate may be a polymer formed from alkylene monomers. In some examples, the polymer substrate may comprise an acrylic substrate. In some examples, the polymer substrate comprises acrylic, polyethylene (PE), linear low density polyethylene (LLDPE), low density polyethylene (LDPE), medium density polyethylene (MDPE), high density polyethylene (HDPE), polypropylene (PP), cast polypropylene (cPP), biaxially oriented polypropylene (BOPP), polyamide (PA), oriented polyamide (OPA), or polyethylene terephthalate (PET). In some examples, the substrate is used as flexible packaging.

In some examples, the substrate may comprise a plurality of layers of material, in some examples, a plurality of layers of material laminated together affording a multi-layer substrate. In some examples, the substrate may comprise a plurality of layers of material selected from polymeric materials (e.g., polymeric materials selected form PE, LLDPE, MDPE, PP, cPP, BOPP, PA, OPA and PET), metallic materials (e.g., metallic foils such as aluminium foil, or metallized substrates such as metallized-PET or metallized BOPP), paper and combinations thereof. In some examples, the substrate comprises a plurality of layers of polymeric material (such as a combination of layers selected from PE, LLDPE, MDPE, PP, BOPP, PET and OPA) laminated together. In some examples, this substrate is corona treated before the electrostatic ink composition is electrostatically printed on its surface.

In some examples, the substrate comprises polypropylene and the polypropylene is corona treated before the electrostatic ink composition is electrostatically printed on the surface of the polypropylene.

In some examples, the substrate comprises polyethylene terephthalate and no corona treatment is used before the liquid electrophotographic ink composition is liquid electrophotographically printed on the surface of the polypropylene.

In some examples, the substrate has a thickness of 300 pm or less, for example, 250 pm or less, 200 pm or less, 150 pm or less, 100 pm or less, 90 pm or less, 80 pm or less, 70 pm or less, 60 pm or less, 50 pm or less, 40 pm or less, 30 pm or less, 20 pm or less, or 15 pm or less. In some examples, the substrate has a thickness of 15 pm or more, for example, 20 pm or more, 30 pm or more, 40 pm or more, 50 pm or more, 60 pm or more, 70 pm or more, 80 pm or more, 90 pm or more, or 100 pm or more. In some examples, the substrate has a thickness of 15 pm to 100 pm, for example, 20 pm to 90 pm, 30 pm to 80 pm, 40 pm to 70 pm, or 50 pm to 50 pm.

### EXAMPLES

The following illustrates examples of the methods and other aspects described herein.

Thus, these Examples should not be considered as limitations of the present disclosure, but are merely in place to teach how to make examples of the present disclosure.

### Materials

### Thermoplastic Resins

Poly(ethylene-co-glycidyl methacrylate): a copolymer of ethylene and glycidyl methacrylate containing 6.5 to 9.0 wt. % glycidyl methacrylate with a melt flow rate of 4.0 g/10 min to 6.0 g/10 min (190° C./2.16 kg); available as pellets from Sigma-Aldrich™ under product number 430862.

Poly(ethylen-co-ethylacrylate-maleic acid anhydride): a copolymer of ethylene, ethylacrylate, and maleic acid anhydride containing 6.5 wt. % ethyl acrylate and 2.8 wt. % maleic acid anhydride with remainder being ethylene. Available from Arkema as Lotader™ 8200 as pellets.

### Carrier Liquid

Isopar L™: an isoparaffinic oil comprising a mixture of C11-C13 isoalkanes; produced by Exxon Mobil™; CAS number 64742-48-9.

### Pigment

Main cyan pigment: LIONOL BLUE FG-7351; produced by Toyo Chem.
Secondary cyan pigment: HELIOGEN GREEN D8730; produced by BASF

### Example 1—Preparation of Liquid Electrophotographic Inks

A first paste was prepared by mixing poly(ethylene-co-glycidyl methacrylate) resin (1000 g) with Isopar L™ (2000 g) at 60 rpm in a ROSS mixer (33.3 wt. % non-volatile solids (NVS). The mixing procedure is outlined in Table 1 and results in the formation of a resin paste containing poly(ethylene-co-glycidyl methacrylate) (i.e., the copolymer of an alkylene monomer and an ethylenically unsaturated monomer comprising an epoxide group). The resin paste was prepared carrying out the following steps at the given temperatures in sequence:

TABLE 1

| Mixer temperature (° C.) | Mixing time (min) |
|---|---|
| 130 | 120 |
| 105 | 30 |
| 100 | 30 |
| 90 | 30 |
| 25 | 120 |

A second paste was prepared by mixing poly (ethylen-co-ethylacrylate-maleic acid anhydride) resin (1000 g) with Isopar L™ (2000 g) at 60 rpm in a ROSS mixer (33.3 wt. % non-volatile solids (NVS). The mixing procedure is outlined in Table 2 and results in the formation of a resin paste containing poly(ethylen-co-ethylacrylate-maleic acid anhydride), i.e. the copolymer comprising a monomer comprising an anhydride group. The resin paste was prepared carrying out the following steps at the given temperatures in sequence:

TABLE 2

| Mixer temperature (° C.) | Mixing time (min) |
|---|---|
| 130 | 180 |
| 95 | 45 |
| 85 | 30 |
| 25 | 120 |

Cyan inks were prepared from the above two pastes by combining the components listed in Table 4 in an S1 reactor filled with metal grinding ball and using the following ratios of first (E resin) and second (MA resin) resin pastes (see Table 3):

TABLE 3

| | | | | | Moles | Moles | |
|---|---|---|---|---|---|---|---|
| Ink | % MA | % E | MA in | E in | of MA | of E | MA/E |
| Sample | resin | resin | sample | sample | groups in | groups in | mole |
| # | (w/w) | (w/w) | (g) | (g) | sample | sample | ratio |
| 1 | 100% | 0% | 33.6 | 0 | 0.343 | 0.000 | 1/0 |
| 2 | 75% | 25% | 25.2 | 24 | 0.257 | 0.169 | 3/2 |
| 3 | 50% | 50% | 16.8 | 48 | 0.171 | 0.338 | 1/2 |
| 4 | 20% | 80% | 6.72 | 76.8 | 0.069 | 0.541 | 1/8 |
| 5 | 10% | 90% | 3.36 | 86.4 | 0.034 | 0.608 | 1/18 |
| 6 | 0% | 100% | 0 | 96 | 0.000 | 0.676 | 0/1 |

TABLE 4

| Sample #1 | Quantity (g) |
|---|---|
| Epoxy resin | 0 |
| MA resin | 1200 |
| Main C pigment | 59.2 |
| Secondary C | 4.4 |
| pigment | |
| Isopar | 800 |
| Sample #2 | Quantity (g) |
| Epoxy resin | 300 |
| MA resin | 900 |
| Main M | 59.2 |
| pigment | |
| Secondary M | 4.4 |
| pigment | |
| Isopar | 800 |
| Sample #3 | Quantity (g) |
| Epoxy resin | 600 |
| MA resin | 600 |
| Main M | 59.2 |
| pigment | |
| Secondary | 4.4 |
| M pigment | |
| Isopar | 800 |
| Sample #4 | Quantity (g) |
| Epoxy resin | 960 |
| MA resin | 240 |
| Main C pigment | 59.2 |
| Secondary C | 4.4 |
| pigment | |
| Isopar | 800 |
| Sample #5 | Quantity (g) |
| Epoxy resin | 1080 |
| MA resin | 120 |
| Main C | 59.2 |
| pigment | |
| Secondary C | 4.4 |
| pigment | |
| Isopar | 800 |
| Sample #6 | Quantity (g) |
| Epoxy resin | 1200 |
| MA resin | 0 |
| Main C | 59.2 |
| pigment | |
| Secondary C | 4.4 |
| pigment | |
| Isopar | 800 |

MA resin: Poly(ethylen-co-ethylacrylate-maleic acid anhydride): a copolymer of ethylene, ethylacrylate, and maleic acid anhydride containing 6.5 wt. % ethyl acrylate and 2.8 wt. % maleic acid anhydride with remainder being ethylene. Available from Arkema as Lotader ™ 8200 as pellets.
Epoxy resin: (Poly(ethylene-co-glycidyl methacrylate): a copolymer of ethylene and glycidyl methacrylate containing 6.5 to 9.0 wt. % glycidyl methacrylate with a melt flow rate of 4.0 g/10 min to 6.0/10 min (190° C./2.16 kg); available as pellets from Sigma-Aldrich ™ under product number 430862.
Main C pigment: cyan pigment LIONOL BLUE FG-7351; produced by Toyo Chem. Secondary C pigment: cyan pigment HELIOGEN GREEN D8730; produced by BASF
ISOPAR: carrier liquid: Isopar L ™: an isoparaffinic oil comprising a mixture of C11-C13 isoalkanes; produced by Exxon Mobil ™; CAS number 64742-48-9.

The components were mixed at 25° C. for 20 hours. Ink solutions at about 10% NVS (w/w) were unloaded. For electroplated and printed samples, working ink solutions were prepared by diluting unloaded ink solution to a final ˜2% (w/w) NVS concentration using Isopar.

### Example 2—Electrodeposition of Samples #1 to #6 and Reference Ink

All prepared MA/E resins (compositions based on above Tables 3 and 4) and the reference ink (the reference ink comprising polyethylene-co-acrylic acid and polyethylene-co-methacrylic resins, the same carrier liquid as in samples 1-6 and 13% pigment) were electrodeposited using an internal Q/M instrument set up for simulating electric field applied on LEP inks during printing process. It comprises two electrodes biased at 1500V (as applied on ink to transfer it from the negatively charge PIP roll (−900V) to the positively charged blanket roll held at +600V. The behavior of an experimental LEP ink is tested this way prior to printing.

All samples were plated on mix-pap substrate, which is a multi-layer substrate, without primer assistance. The mix-pap substrate, which is a multi-layer substrate, had been corona treated before plating. All samples were dried at ˜80° C. hot plate followed by additional 5 minutes curing at 120° C. heating stage in oven. Finally, all samples were coated using draw-down (rod #4) method with commercially heat-sealing varnish (SENOLITH® WB protective coating heat resistant FP NDC 17-3516 350668, by Weilburger). Sealing tests were performed using HSG-C Heat-Sealing Machine (Brugger) with radial jaws, 250° C. temperature, 400N force and 1 second dwell time.

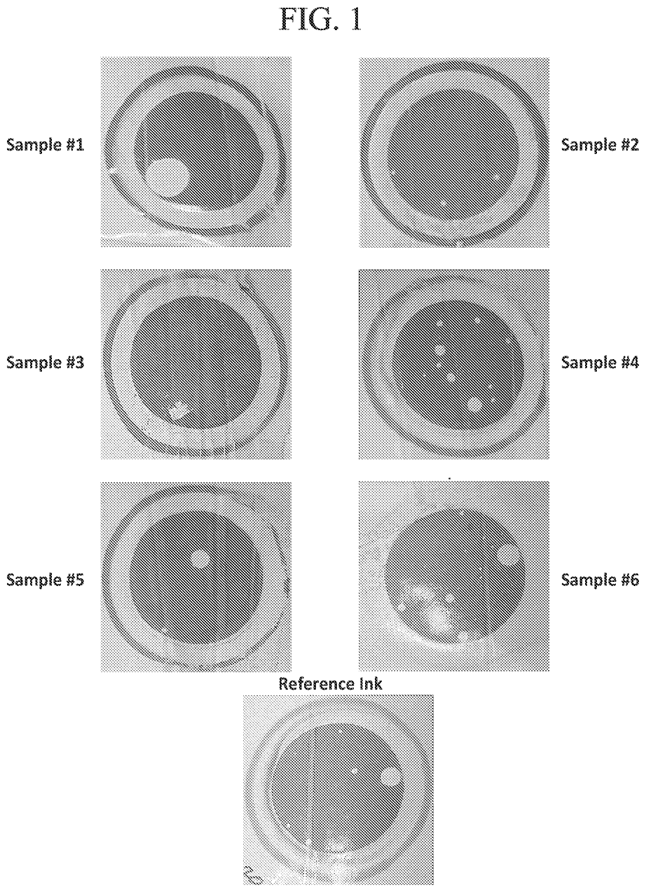

As visible from FIG. 1, the reference ink presented the most defected sealing pattern and thus the worst thermal durability. Ink samples #2 and #3 presented the best thermal durability with negligible thermal defects while the remaining inks presented some extent of thermal durability. Based on the obtained visual observations, an arbitrary thermal durability scale of examined inks will be as follow:

reference ink<Sample #1<Sample #5<Sample #4<Sample #6<Sample #3<Sample #2

The obtained results present effectively the different heat-sealing behavior of LEP inks based on thermoplastic resins like the above reference ink in comparison to LEP inks based on curable resins (e.g. epoxy and maleic anhydride). Furthermore, cured maleic anhydride resin will presumably result solely in surface reaction with the substrate while epoxy-based resin and especially its mixtures with cross-linking maleic anhydride resin might result in cross-linked ink layer. This is clearly noticed in sample #1 (100% maleic anhydride resin) in comparison to sample #6 (100% epoxy resin). Samples #2, and #3 presented minimal heat-sealing damage since the MA/E functional groups ratio is around 1 (1 mole of maleic anhydride and 1 mole epoxy functional groups, corresponding to reaction of one carboxylic group of the maleic anhydride moiety with one epoxy group).

### Example 3—Electrodeposition of Samples #2 and #3 and an Additional Reference Ink

Above Samples #2 and #3 mixed resin inks were printed using 6800 Indigo web printing machine. No primer was used for pre-treatment and thus ILP (inline priming unit) was used for corona treatment. All inks were printed using default printing conditions (used for the above reference ink and additional reference ink) after automatic color calibration. Mix-pap substrate (Amcor's 50251 with v17 PET-met paper for lids, which is a multi-layer substrate) was used for printing of all samples. Finally, samples were coated using draw-down (rod #4) method with commercially heat-sealing varnish (SENOLITH® WB protective coating heat resistant FP NDC 17-3516 350668, by Weilburger). Sealing tests were performed using HSG-C Heat-Sealing Machine (Brugger) with radial jaws, 250° C. temperature, 400N force and 1 second dwell time.

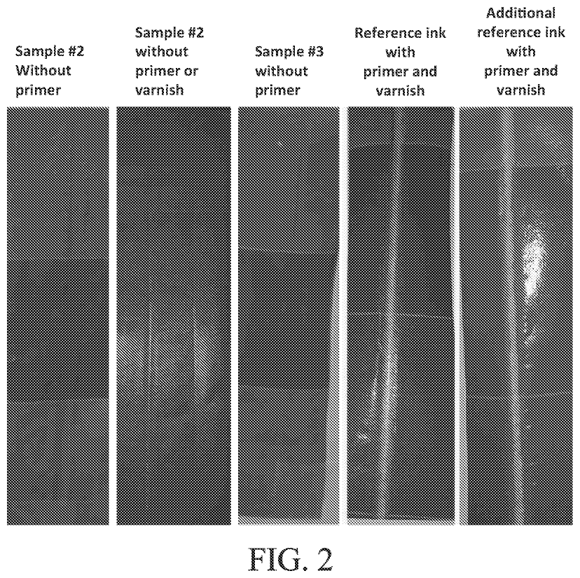

In light of the above obtained results, Cyan sample inks #2, #3 were printed in different coverages (100%-360%) without primer assistance on mix-pap substrate (a multi-layer substrate). Heat-sealing test was performed on the printed images with/without varnish assistance. The obtained results are presented in comparison to a sample of the above reference ink and additional reference ink based on the similar carboxylic acid containing resins comprising higher pigment loading values (20% compared to 13% in the above reference ink). FIG. 2 presents the obtained heat-sealing results.

Samples #2 and #3 printed without primer assistance and without varnish presented significantly superior heat-sealing resistance results (no visible damage) in comparison to aforesaid reference inks printed over the primer DG050 primer (from Michelman based on PEI chemistry) which show a vertical decolored line in the figures, which is indicative of sealing damage. Sample #2 presented perfect heat-sealing durability even without varnish treatment.

### Example 4—Heat-Sealing Durability of Samples #2 and #3 Using a Yoghurt Cup Sealing Apparatus

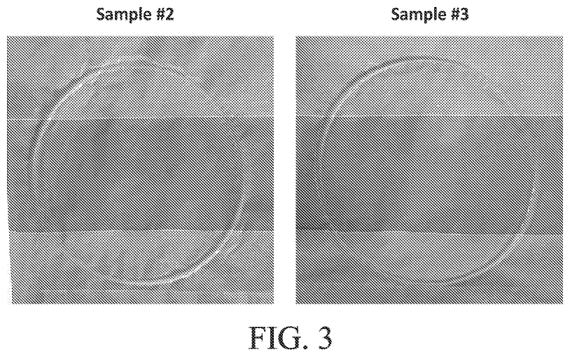

The heat-sealing durability of samples #2, #3 was tested in a commercial yogurt cups sealing apparatus. Sealing tests were performed using Semi-Auto LID Sealing (SIS) instrument using the following parameters: 250° C. temperature, 3 bars force and 1 second dwell time. FIG. 3 presents the heat-sealing results of printed Cyan #2, #3 inks on mix-pap substrate (a multilayer substrate) without primer assistance treated with varnish (printed substrate were hot-molded on top of PS cups).

Both primer-less printed inks presented excellent heat-sealing results (printed sample #2 presented perfect durability).

1. A liquid electrophotographic ink composition comprising:
a carrier liquid
one or more pigments;
a first thermoplastic resin comprising a copolymer comprising an alkylene monomer and a monomer comprising an epoxide group, and
a second thermoplastic resin comprising a copolymer comprising a monomer comprising an anhydride group.

2. The liquid electrophotographic ink composition according to claim 1, wherein the monomer comprising an epoxide group is an ethylenically unsaturated monomer comprising an epoxide group.

3. The liquid electrophotographic ink composition according to claim 2, wherein the ethylenically unsaturated monomer comprising an epoxide group is an ester of an ethylenically unsaturated carboxylic acid and an epoxide group-containing alcohol.

4. The liquid electrophotographic ink composition according to claim 3, wherein the epoxide group-containing alcohol comprises a terminal epoxide group.

5. The liquid electrophotographic ink composition according to claim 1, wherein the copolymer of the first thermoplastic resin is poly(ethylene-co-glycidyl methacrylate).

6. The liquid electrophotographic ink composition according to claim 1, wherein the monomer comprising an anhydride group is an ethylenically unsaturated monomer comprising an anhydride.

7. The liquid electrophotographic ink composition according to claim 6, wherein the ethylenically unsaturated monomer comprising an anhydride group is a maleic acid anhydride.

8. The liquid electrophotographic ink composition according to claim 1, wherein the copolymer of the second thermoplastic resin further comprises at least one monomer selected from the group consisting of an alkylene monomer and alkenoic acid alkyl ester monomer.

9. The liquid electrophotographic ink composition according to claim 8, wherein the alkenoic acid alkyl ester monomer is a propenoic-C1 to C4-alkyl-ester monomer.

10. The liquid electrophotographic ink composition according to claim 1, wherein the alkylene monomer is selected from the group consisting of ethylene and propylene.

11. The liquid electrophotographic ink composition according to claim 1, wherein the copolymer of the second thermoplastic resin is poly(ethylene-co-ethylacrylate-co-maleic acid anhydride).

12. The liquid electrophotographic ink composition according to claim 1, wherein the molar ratio of the monomer comprising an anhydride of the copolymer of the second thermoplastic resin to the monomer comprising an epoxide of the copolymer of the first thermoplastic resin is about 0.4 to about 1.7 based on the weight percentage of the respective monomer in the respective copolymer.

13. A method of printing comprising:
liquid electrophotographically printing a liquid electrophotographic ink composition on a surface of a substrate, wherein the liquid electrophotographic ink comprises a first thermoplastic resin comprising a polymer of an ethylenically unsaturated monomer comprising an epoxide group, and a second thermoplastic resin comprising a polymer of an ethylenically unsaturated monomer comprising an anhydride group and an alkenoic acid alkyl ester monomer; and
applying the liquid electrophotographic ink composition on the surface of the substrate such that the epoxide group and the anhydride group react with the surface of the substrate and crosslink.

14. A substrate having liquid electrophotographically printed thereon a liquid electrophotographic ink composition comprising a first thermoplastic resin comprising a copolymer comprising an alkylene monomer and a monomer comprising an epoxide group, and a second thermoplastic resin comprising a copolymer comprising a monomer comprising an anhydride group, wherein the epoxide group and the anhydride group have reacted with the surface of the substrate and have crosslinked.

15. The substrate according to claim 14, wherein the substrate is a multi-layer substrate.
